(19) United States
(12) Patent Application Publication
(10) Pub. No.: US 2008/0257174 A1
(43) Pub. Date: Oct. 23, 2008

(54) Smoker box

(76) Inventor: W. Clark Turner, Columbus, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/787,632

(22) Filed: Apr. 17, 2007

(51) Int. Cl. A23B 4/044

(52) U.S. Cl. 99/516

(57) ABSTRACT

A smoker box is disclosed for use in imparting smoked flavor to foods being cooked on a grill or outdoor oven. The smoker box has a tray for holding wood chips or the like and a base for holding the tray in spaced relationship therefrom.

### TECHNICAL FIELD

The present invention generally relates to a smoker box used for imparting smoked flavor to foods during outdoor cooking.

### DESCRIPTION OF THE RELATED ART

Outdoor cooking can take many forms. From the earliest campfires to sophisticated modern barbecue grills, the popularity of outdoor cooking continues to grow. One of the biggest attractions of outdoor cooking is the smoked flavor imparted to the food. Smoker grills use indirect low heat to impart smoked flavor over a fairly lengthy cooking period. Charcoal grills generally cook much faster and impart a smoky, charcoal flavor to foods. Gas grills, which are the most widely used outdoor cooking product, are generally not as adept at imparting a smoky flavor.

In an effort to improve the performance of gas grills with respect to imparting a smoky flavor to foods, two main avenues have been followed. In one method, wood chips are embedded in a ceramic material that serves as a radiant means for gas grills. As the ceramic briquettes or, in some cases, plates are heated, the wood chips are slowly charred and burned, with consequent smoke emanation. In a second, and more widely used method, wood chips are placed in a metallic box that is then placed within the grill. As the metallic box is heated, the wood chips char and give off smoke.

While in relatively wide use, smoker boxes found in the prior art have drawbacks. Due to the need to prevent the wood chips from igniting and to provide a sturdy product for a difficult environment, many of such boxes inhibit the desired combustion. They may be overly thick, too inhibitive of air flow, or simply unwieldy to use. Such products are also often unsightly and difficult to clean and store after use.

Thus, it can be seen that a need exists for a smoker box that is efficient and easy to use and store, and which avoids problems found with the prior art.

### SUMMARY

A smoker box is disclosed that has a top portion and a bottom portion. The top portion is designed to receive wood chips for use in imparting a smoky flavor to foods being cooked nearby in a grill or outdoor stove. The bottom portion serves as a stand for the top, may be spaced therefrom, and is designed to facilitate airflow around the smoker box. After and between uses, the top and bottom portions are sized to nest together for compact storage.

Various additional attributes and advantages of the disclosed smoker box will become apparent from the following detailed description, taken in conjunction with the appended drawing figures.

### BRIEF DESCRIPTION OF THE DRAWINGS

FIG. 1 is a perspective view of an embodiment of a smoker box in use in conjunction with a barbecue grill;

FIG. 2 is a exploded perspective view of an embodiment of a smoker box in one operative position; and

FIG. 3 is a perspective view of an embodiment of a smoker box, with a portion of the top partially cut away to illustrate a storage position.

### DETAILED DESCRIPTION

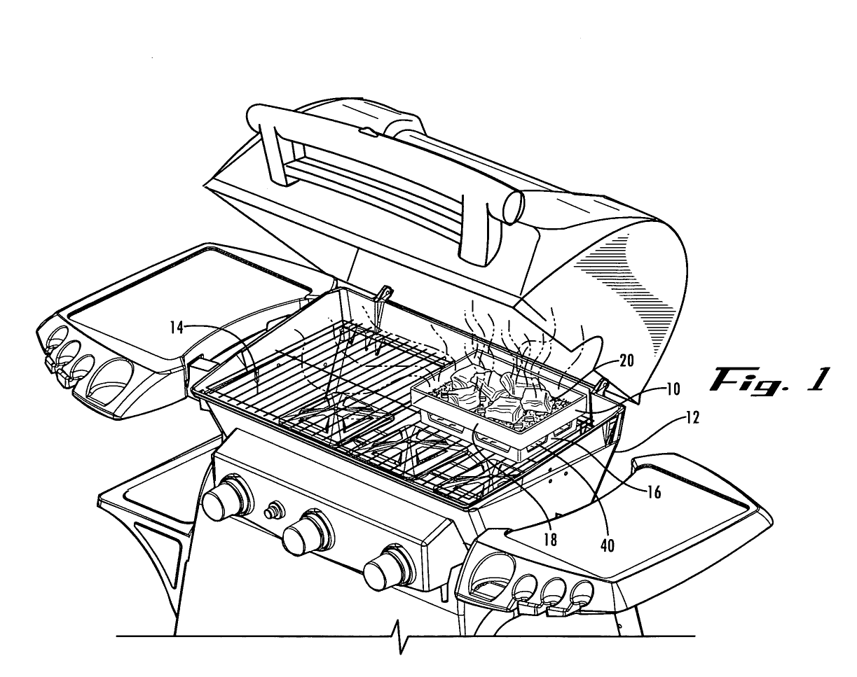

Referring now to the drawings and more specifically to FIG. 1 numeral 10 designates generally an embodiment of a smoker box. The smoker box is shown in use in conjunction with a gas grill 12. The smoker box is normally disposed on the cooking grate 14 where it is designed to remain during the cooking process, depending on the flavoring requirements or desires of the user. The smoker box may also be placed on a warming rack, (not shown) which is normally spaced from the main cooking grate, or in a drawer or the like, which is specifically designed to hold such a device in an operative position near the heat source. The smoker box includes a base 16, upon which sits a tray 18. The tray is designed to hold wood chips 20 or the like for use in imparting smoke flavor to the food being cooked on the grill. The smoker box is normally formed from iron, steel, aluminum, or other heat resistant material in order to withstand the extremes of heat possible in a barbecue grill. While shown in use with a gas grill, it will be understood by those of ordinary skill in the art that such a device can also be use with any type of barbecue grill, for example charcoal grills, electric grills, smokers, etc.

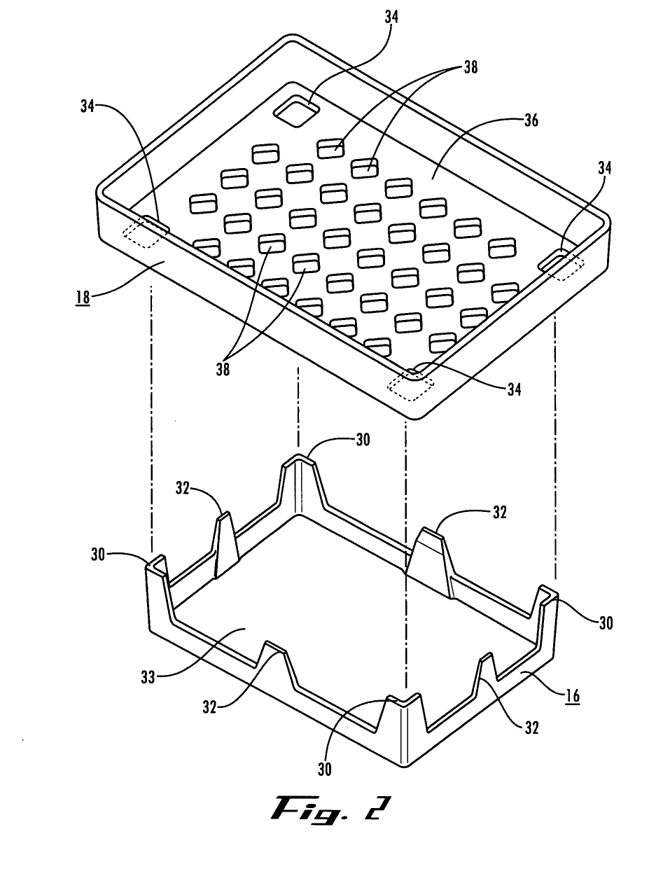

FIG. 2 is an exploded view of an embodiment of a smoker box. As can be seen, the base 16 includes a plurality of corner posts 30 and a plurality of side posts 32, which are generally spaced around the outer perimeter of the base, although other locations and configurations are possible. The base is formed with a substantially continuous bottom panel 33, which is designed to radiate heat received from the heat source of the grill and to catch any ashes produced by the combustion of the wood chips disposed in the tray 18. Tray 18 includes an aperture 34 at each corner thereof, which, when installed on the base 26, receives the corner post 30. This provides a secure mounting for the tray on the base, which mounting is stabilized by the bottom wall 36 of tray 28 resting on the side posts 22. Such mounting may also be provided by a single upstanding post, or other means designed to space the base from the tray, such as a post projecting downwardly from the tray to engage the base. The bottom wall 36 of tray 18 also includes a plurality of apertures normally spaced throughout the width and length thereof for allowing air circulation through the bottom wall of the tray. These apertures 33 can be formed in any number, shape, and virtually any size which will support the wood chips to be placed therein. It is also contemplated that the tray 18 can have a solid bottom wall.

When the wood chips are placed in the tray as shown in FIG. 1 and the tray is mounted on the base, gaps 40 are formed between each corner post and the side post disposed therebetween. This permits air to circulate around the tray, which enhances combustion, provides a cooling effect to slow down the combustion of the chips, and also promotes circulation to disperse the smoke being produced throughout the barbecue grill. The circulation thus provided helps product the desired effect, dispersion of smoke throughout the cooking chamber, whether or not the bottom wall of the tray is solid or perforated, as shown herein.

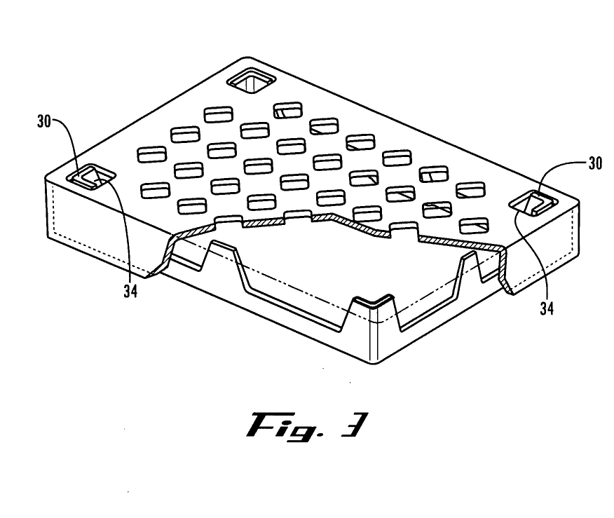

Referring now to FIG. 3, once cooking is complete and the wood chips have been extinguished, the tray 18 is inverted and placed over the base 16. The corner apertures 34 receive the corner posts 30 to provide a secure mounting in the storage position shown in FIG. 3. It is also possible to use the smoker box while in the configuration shown in FIG. 3. In this configuration, wood chips would be placed in the base 16 and covered with the tray 18 as shown, thus adding to the versatility of the device. While shown and described as two separable parts, it will be understood that the base and tray may be connected using hinges, clasps or the like, and subsequently separated or folded into position for use and later for storage.

In the use and operation of a smoker box (such as the embodiment of FIG. 1), the smoker box is assembled into the configuration shown in FIG. 1 or that shown in FIG. 3, depending on the preference of the user. Wood chips, which have typically been soaked in water for a period of time prior to use, are placed either in the tray 18, in the configuration shown in FIG. 1, or in the base 16 in the configuration shown in FIG. 3. The smoker box is then placed on the cooking grate of the barbecue grill, or in another suitable location, where the combination of heat and air circulation causes combustion of the chips and distribution of the smoke throughout the grill, thereby flavoring the food being cooked thereon. After use, the smoker box is easily stored between uses in the configuration shown in FIG. 3.

Thus, while an embodiment of a smoker box and modifications thereof have been shown and described in detail herein, various additional changes and modifications may be made without departing from the scope of the disclosure, as defined by the appended claims.

Therefore, having thus described the invention, at least the following is claimed:

1. A smoker box for use in producing smoke in a cooking environment, comprising a base having a tray mounted thereon in spaced relationship therefrom, whereby combustible material placed in said tray produces smoke due to the combination of applied heat in the cooking environment and air circulation between said base and said tray.

2. A smoker box as defined in claim 1 in which said base includes at least one upstanding post for receiving and seating said tray in spaced relationship therefrom.

3. A smoker box as defined in claim 1 in which said tray has a bottom wall and at least one aperture formed in said bottom wall.

4. A smoker box as defined in claim 1 in which said base and said tray are sized to nest together for use and storage.

5. A smoker box comprising a base and a tray mounted on said base for receiving combustible material for producing smoke to flavor food when subjected to heat in a cooking environment.

6. A smoker box as defined in claim 5 in which said tray is spaced from said base when mounted thereon.

7. A smoker box as defined in claim 5 in which said tray includes a bottom wall and at least one aperture formed in said bottom wall.

8. A smoker box as defined in claim 5 in which said base includes means for spacing said tray from said base.

9. A smoker box as defined in claim 5 in which said tray includes means for spacing said tray from said base.

10. In a cooking environment having a heat source for cooking food, a smoker box comprising a base and a tray mounted on said base in spaced relationship therefrom for allowing air circulation between said base and said tray for dispersing smoke produced from combustible material disposed in said tray.
